(19) United States
(12) Patent Application Publication
(10) Pub. No.: US 2015/0290087 A1
(43) Pub. Date: Oct. 15, 2015

(54) Ergonomical Baby Bottle

(71) Applicants: Libby M. Kirkland, Decatur, IL (US); Christine M. Henderson, Decatur, IL (US)

(72) Inventors: Libby M. Kirkland, Decatur, IL (US); Christine M. Henderson, Decatur, IL (US)

(21) Appl. No.: 14/749,917

(22) Filed: Jun. 25, 2015

(51) Int. Cl. A61J 11/00; A61J 11/02; A61J 9/06

(52) U.S. Cl. CPC A61J 11/0035; A61J 9/0607; A61J 9/0623; A61J 9/0669; A61J 9/0676; A61J 11/0015; A61J 11/002; A61J 11/005; A61J 11/02

(57) ABSTRACT

Disclosed is a baby bottle that is ergonomically shaped and that simulates the shape and feel of a natural female human breast. In one embodiment, the baby bottle includes a bottle portion attached to a nipple portion, wherein the nipple portion includes a tip extending upward therefrom. The surface of the tip and the nipple portion includes ridges and protrusions thereon so as to mimic the texture of a female human areola and nipple. The tip includes multiple perforations thereon. Each of the perforations differs in diameter to simulate flow of breast milk. Additionally, the nipple portion includes dual vent flow openings to equalize pressure within the interior of the bottle while the bottle is in use. The bottle includes a tapered mid-portion so that it is easy to hold for both adults and babies.

### FIELD OF THE INVENTION

The present invention generally relates to a beverage container. More particularly, the present invention is directed to an ergonomic baby bottle with a naturally shaped nipple.

### BACKGROUND OF THE INVENTION

Baby bottles are one of essential items used to feed infants and babies. Baby bottles are generally used to feed infants and babies who are not breast fed, or to feed infants and babies while traveling or in public. Additionally, baby bottles help to soothe a baby because sucking often has a calming effect. Many infants and babies, however, have difficulty transitioning to a baby bottle after being breast fed for a certain period of time because baby bottles often have unnaturally shaped nipples that can feel foreign to infants and babies. Thus, it is desirable to use baby bottles having nipples that mimic the human breast.

Devices have been disclosed in the prior art that claim baby bottles that are convenient for use and that mimic a female human nipple. These include baby bottles that have been patented and published in patent application publications. The foregoing is a list of devices deemed most relevant to the present disclosure, which are herein described for the purposes of highlighting and differentiating the unique aspects of the present invention, and further highlighting the drawbacks existing in the prior art.

Specifically, Holley, U.S. Pat. No. 6,957,744, and Sheehy, U.S. Pat. No. 5,653,732, disclose nipple tips with a plurality of holes disposed thereon. Additionally, Sheehy discloses ascending rings disposed on the nipple tip. However, Holley and Sheehy do not disclose a baby bottle assembly that comprises an ergonomically shaped bottle. Rieppel, U.S. Patent Application Publication Number 2011/0226720, discloses a nipple that can control the flow of liquid therethrough. Rieppel, however, is limited in that it requires a user to use a plurality of nipples in a stacked configuration. Thus, the structural configuration of Rieppel differs significantly from the present invention.

Randolph, U.S. Patent Application Publication Number 2014/0228882, discloses a nipple with a textured areola region. Similarly, Dieringer U.S. Pat. No. 6,161,710, discloses a nipple with a plurality of holes on a tip thereof, and a textured base portion. The nipple is inserted through a collar, which can be removably secured to a bottle via threaded means. Additionally, Dieringer discloses a lid can be removably attached to the collar. The foregoing Randolph and Dieringer references, however, do not disclose a dual vent flow feature of the present invention.

Finally, Lau, U.S. Patent Application Publication Number 2011/0266245, discloses an ergonomically shaped baby bottle with a valve insert hole. However, the valve insert hole of the Lau device is disposed on a liquid reservoir, which may be structurally integral to the bottle. In this regard, the hole is not disposed on the nipple as disclosed in the present invention.

The devices disclosed in the prior art have several known drawbacks, however. These devices are limited in that they do not simulate a natural breast milk flow when the bottle is in use. The present invention overcomes these limitations by disclosing a bottle that includes a naturally shaped nipple and that comprises multiple perforations for allowing milk to flow therethrough. Additionally, the present invention provides a dual vent flow feature for maintaining the interior pressure of the bottle at a constant pressure as the milk is sucked out of the bottle.

### SUMMARY OF THE INVENTION

In view of the disadvantages inherent in the known types of devices for baby bottles now present in the prior art, the present invention provides an improved baby bottle that is ergonomically shaped and that comprises multiple perforations on a nipple thereof for facilitating drinking.

In a preferred embodiment, the present invention comprises a baby bottle assembly that includes a lid, a nipple, a collar, and a bottle. In operation, the nipple is inserted into the collar, and the collar is removably attached to the bottle. The lid can then affix to the collar so as to protect the nipple therein. The bottle is ergonomically shaped so as to allow the user to easily hold the bottle.

The nipple comprises a base portion and a tip, wherein the nipple is shaped similar to a female human nipple. Additionally, each of the exterior surface of the base and the internal portion of the tip comprises texture that mimics the texture of a female human breast. Particularly, the external surface of the base comprises a texture that mimics the texture of an areola. The tip of the nipple comprises a plurality of holes therein. The holes preferably comprise a circular shape with a diameter. The diameter of the holes may vary in size so as to simulate natural breast milk flow. In one embodiment, the diameter of the holes comprises three sizes. Additionally, the tip of the nipple comprises a plurality of ascending rings. In one embodiment, the tip comprises three rings.

Furthermore, the base portion of the nipple comprises a dual vent flow feature. The dual vent flow feature comprises a pair of openings for allowing air to flow therethrough. In one embodiment, the openings are disposed on opposite sides of each other. The openings are adapted to equalize the pressure within the interior of the bottle when the bottle is in use.

It is therefore an object of the present invention to provide a baby bottle that is ergonomically shaped.

It is another object of the present invention to provide a baby bottle having a nipple portion that mimic the texture and shape of a female human nipple.

It is still another object of the present invention to provide a baby bottle having a nipple portion with a dual vent flow feature for facilitating the flow of liquid contents therein.

It is still another object of the present invention to provide a baby bottle having a nipple portion with multiple perforations thereon to simulate a natural breast milk flow.

It is still another object of the present invention to provide a baby bottle that is composed of eco friendly, safe, and non-toxic materials.

A final object of the present invention to provide a baby bottle that may be readily fabricated from materials that permit relative economy and commensurate with durability.

In the light of the foregoing, these and other objects are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a front elevational view of an exemplary embodiment of the present invention.

FIG. 2 is a disassembled view of the exemplary embodiment of the present invention.

FIG. 3 shows a front elevational view of the present invention with a lid thereon.

FIG. 4 shows close up view of the nipple portion of the present invention.

### DETAILED DESCRIPTION OF THE INVENTION

The present invention is directed towards an ergonomically shaped baby bottle that comprises multiple perforations on a nipple portion. For purposes of clarity, and not by way of limitation, illustrative views of the present baby bottle are described with references made to the above-identified figures. Various modifications obvious to one skilled in the art are deemed to be within the spirit and scope of the present invention.

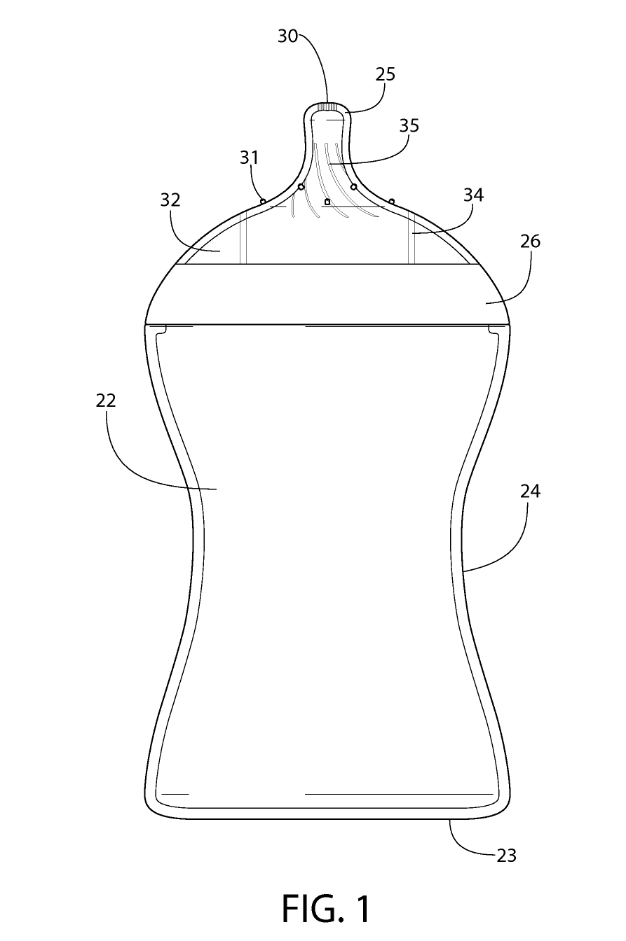

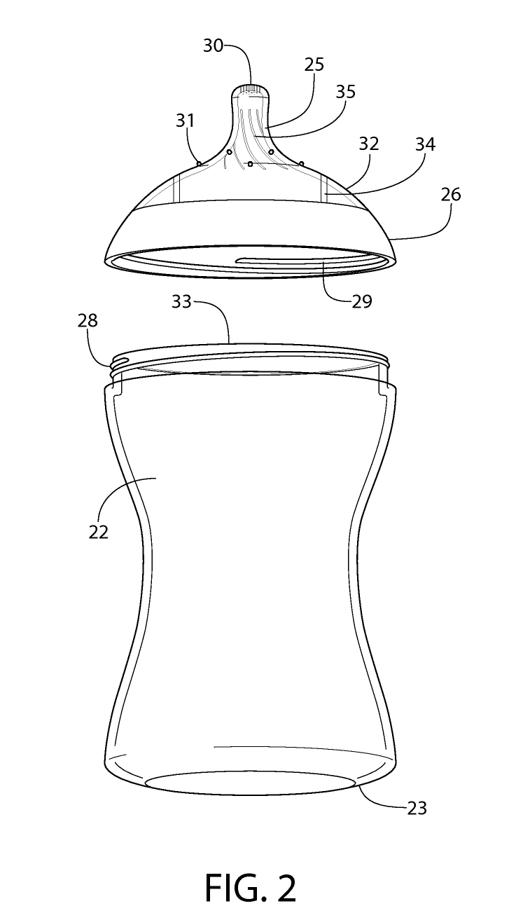

Referring now to FIGS. 1 and 2, there are shown front elevational view and a disassembled view of the present invention, respectively. The baby bottle of the present invention comprises a bottle portion 22 that is removably attached to a nipple portion 32. The bottle portion is substantially cylindrical in shape and includes a defined interior volume for holding liquid therein. The bottle portion 22 comprises an open upper end 33 and a closed lower end 23, wherein the distance between the upper end 33 and the lower end 23 of the bottle portion 22 comprises a height of the bottle portion 22. The bottle portion 22 comprises a circular cross section having a diameter that varies along the height of the bottle portion 22. Preferably, substantial mid-portion of the bottle portion 22 is tapered so as to allow a user to easily grasp the bottle portion 22.

The nipple portion 32 comprises a tip 25 on an upper end thereof, and a collar 26 on a lower end thereof. The tip 25 is centrally located on the nipple portion 32 and is shaped similarly to a female human nipple and also comprises a texture that mimics a female human nipple. For instance, the tip 25 may comprise ridges or outwardly protruding annular rings therearound, wherein the annular rings are in an ascending configuration and the rings are separated at regular intervals. Additionally, the interior of the tip 25 comprises spiral ridges 35 that can be felt in the baby's mouth while the present invention is in use.

Additionally, the nipple portion 32 comprises textured outer surface 31 that mimics the texture of a female human breast. Particularly, the exterior surface of the nipple portion 32 at the base of the tip 25 comprises a texture that mimics the texture of an areola. The tip 25 of the nipple portion 32 comprises multiple perforations 30 thereon. Each of the perforations 30 comprises a substantial circular shape with a diameter. The diameter of the perforations 30 may vary in size so as to simulate natural breast milk flow. In one embodiment, the diameter of the perforations 30 comprises three different sizes. In other embodiments, however, the perforations 30 may comprise more than three different sizes or fewer than three different sizes.

The nipple portion 32 comprises additional perforations or openings near the collar 26 thereof for providing dual vent flow. In one embodiment, the additional perforations comprise a pair of perforations 34 on opposite sides of the nipple portion 32. The dual vent flow openings 34 may be located on other parts of the nipple portion 32, however, depending upon embodiment. The perforations are adapted to equalize the pressure within the interior of the bottle portion 22 when the present invention is in use. In this way, the pressure in the interior volume of the bottle portion 22 does not increase and is maintained at a constant pressure as the liquid is sucked out of the interior volume.

In operation, the nipple portion 32 can separate from the collar 26 for cleaning or for replacement. The collar 26 comprises an annular shape with an opening centrally located thereto. The nipple portion 32 is inserted into the opening of the collar 26 from the lower end of the collar 26 and then pulled in an upward direction. Because the diameter of the lower end of the nipple portion 32 is greater than the diameter of the upper end of the collar 26, the nipple portion 32 does not pull all the way through the collar 26. After the nipple portion 32 is secured to the collar 26, the collar 26 can removably attach to the bottle portion 22 via screw means.

In this regard, the upper end 33 of the bottle portion 22 comprises threaded elements 28 thereon. The threaded elements 28 are configured to engage complimentary threaded elements 29 disposed on the interior surface of the collar 26 of the nipple portion 32. When the collar 26 is secured to the upper end 33 of the bottle portion 22, the perforations 30 at the tip 25 of the nipple portion 32 is in fluid communication with the interior volume of the bottle portion 22 so as to allow liquid to flow therethrough.

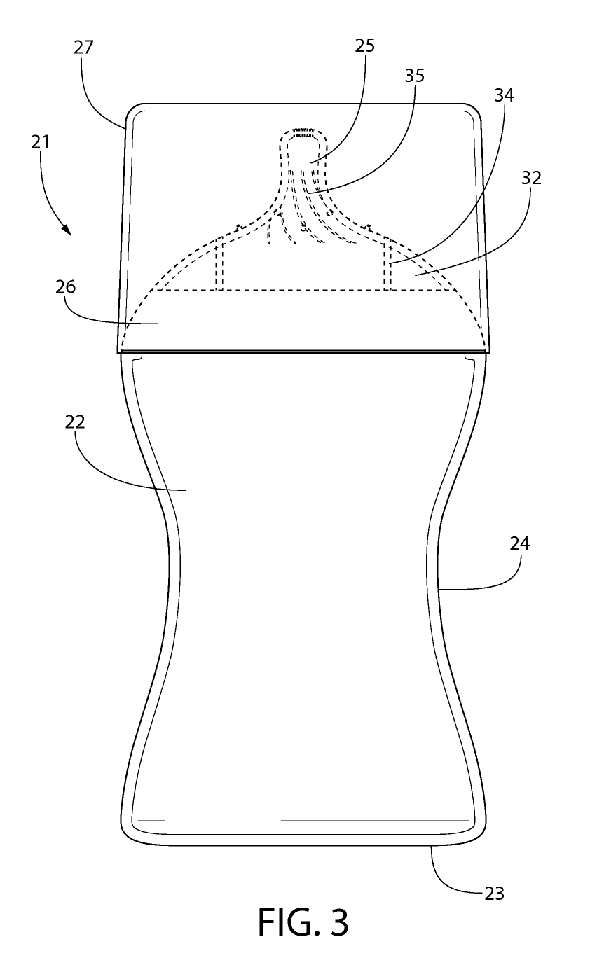

When the present invention is not in use, the nipple portion 32 may be enclosed under a lid 27 so as to protect the nipple portion 32 from outside elements and debris, as illustrated in FIG. 3. In the illustrated embodiment, the lid 27 comprises a substantially cylindrical shape with a circular cross section having a diameter that is uniform over its length. In other embodiments, however, the lid 27 may comprise other shapes. The lid 27 comprises a closed upper end, an open lower end, and hollow interior. In the illustrated embodiment, the lid 27 is secured to the collar 26 via press-fit. In other embodiments, however, the lid 27 may be secured to the collar 26 via other securing means, such as screw means or snap-fit means. The lid 27 is dimensioned so that the interior of the upper end of the lid 27 does not contact the tip 25 of the nipple portion 32 when the lid 27 is secured to the collar 26.

The nipple portion 32 and the bottle portion 22 are preferably composed of eco friendly, non-toxic, and safe materials. Accordingly, the present invention is composed of materials that are free of formaldehyde, heavy metals, phthalates, latex, lead, BPA, PVC, wood stains, varnishes, and VOCs. Additionally, the nipple portion 32 and the bottle portion 22 are composed of materials that can withstand high heat and water pressure. Thus, the present invention may be safely used in a dishwasher and/or in a microwave. In some embodiments, the mid-portion 24 of the bottle portion 22 may comprise a high friction surface so as to prevent the baby bottle from slipping when in use. The high friction surface may comprise a rubber sleeve or another suitable material.

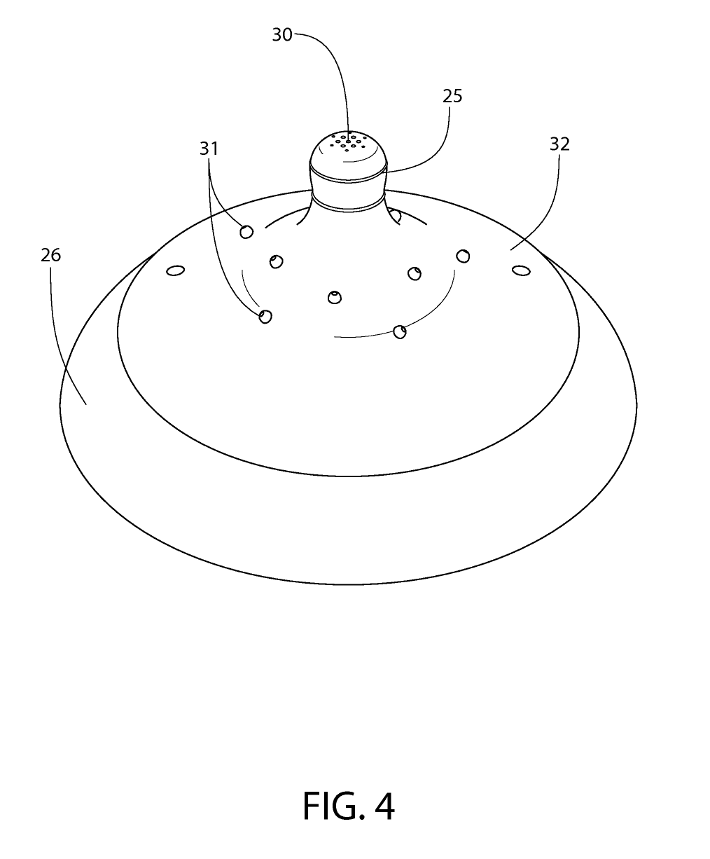

Referring now to FIG. 4, there is shown a close up view of the nipple portion of the present invention. The nipple portion 32 may be molded such that the textured outer surface 31 is similar to an areola of a female human breast. In this way, the textured outer surface 31 includes ridges and protruding elements, wherein some or all of the protruding elements may be substantially round in shape.

Similarly, the tip 25 of the nipple portion 32 may be textured to mimic a female human nipple. The tip 25 may comprise horizontal and/or vertical ridges or protrusions as well as spiral ridges that extend from the base of the tip 25 to the top of the tip 25. The ridges and the protrusions are preferably disposed on both exterior and interior of the tip 25. Additionally, it is preferred that the tip 25 of the nipple portion 32 is integral thereto such that the nipple portion 32 is unitary in structure. In a preferred embodiment, the nipple portion 32 is denser near the collar 26 than at near the base of the tip 25 to provide a natural breast feel and reflex.

When the nipple portion 32 is secured to the collar 26, the nipple portion 23 and the collar 26 form a substantially contiguous surface, which extend from the lower end of the collar 26 to the nipple portion 32. In this regard, the nipple portion 32 and the collar 26 form a dome shape when viewed from the side. Additionally, the collar 26 is arced so as to form a smooth transition to the bottle portion of the present invention.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A baby bottle, comprising:
a nipple portion that is removably attached to a collar;
said nipple portion comprising one or more dual vent flow openings and a tip having one or more perforations thereon;
wherein each of said one or more perforations vary in diameter;
further wherein said nipple portion comprises a texture that mimic a texture of a female human breast;
said collar removably attached to a bottle portion; and
said bottle portion having a defined interior volume for holding liquid therein.

2. The baby bottle of claim 1, wherein said bottle portion comprises an open upper end and a closed lower end;
said upper end of said bottle portion comprising threaded elements;
wherein said collar comprises complementary threaded elements on an interior surface thereof;
said threaded elements of said upper end of said bottle portion configured to engage said complementary threaded elements of said interior surface of said collar.

3. The baby bottle of claim 1, further comprising a lid;
wherein said lid is removably attached to said collar via press-fit.

4. The baby bottle of claim 1, wherein said bottle portion comprises a tapered mid-portion.

5. The baby bottle of claim 1, wherein said nipple portion comprises an outer surface having a texture that mimic a texture of a female human areola.

6. The baby bottle of claim 1, wherein said tip comprises a texture that mimic a texture of a female human nipple.

7. The baby bottle of claim 1, wherein said one or more dual vent flow openings comprise a first opening and a second opening on opposite sides of said nipple portion.

8. The baby bottle claim of 1, wherein an outer surface of said nipple portion and an outer surface of said collar are substantially contiguous.

9. A nipple for a baby bottle, comprising:
a nipple portion having a tip centrally located thereon;
said nipple portion comprising protrusions and ridges so as to mimic a texture of a female human areola;
said tip comprising one or more perforations;
each of said perforations having a different diameter to simulate a natural breast milk flow;
said tip comprising ridges that extend from a base of said tip to a top of said tip; and
dual vent flow openings on opposing sides of said nipple portion.

10. The nipple of claim 9, wherein said ridges comprise annular rings that ascend from said base of said tip to said top of said tip;
said annular rings separated at regular intervals.

11. The nipple of claim 9, wherein said ridges are in a spiral configuration.

12. The nipple of claim 9, wherein said protrusions on said nipple portion are substantially round in shape.

13. A baby bottle, comprising:
a nipple portion comprising one or more dual vent flow openings and a centrally located tip having one or more perforations thereon;
each of said one or more perforations varying in diameter to simulate a natural breast milk flow;
wherein an exterior surface of said nipple portion comprises a texture that mimic a texture of a female human areola;
further wherein said tip comprises a texture that mimic a texture of a female human nipple;
a collar comprising an annular shape and an opening that is configured to receive said nipple portion therethrough;
said collar removably attached to a bottle portion;
said bottle portion having a defined interior volume for holding liquid therein;
wherein said bottle portion comprises a tapered mid-portion.
